(19) United States
(12) Patent Application Publication
(10) Pub. No.: US 2019/0384120 A1
(43) Pub. Date: Dec. 19, 2019

(54) LIQUID CRYSTAL DISPLAY DEVICE

(71) Applicant: SHARP KABUSHIKI KAISHA, Sakai City (JP)

(72) Inventor: NORIYUKI JOHYAMA, Sakai City (JP)

(21) Appl. No.: 16/439,060

(22) Filed: Jun. 12, 2019

Related U.S. Application Data
(60) Provisional application No. 62/685,575, filed on Jun. 15, 2018.

(51) Int. Cl. G02F 1/1337; F21V 8/00; G02F 1/1335

(52) U.S. Cl. CPC G02F 1/133711; G02F 2001/133607; G02F 1/133606; G02B 6/0025

(57) ABSTRACT

A liquid crystal display device includes a light source, a light guide plate including plate surfaces and guiding light and exiting the light through a light emission surface that is one of the plate surfaces, an optical sheet that includes films overlapping the light guide plate on a light emission surface side and imparts an optical action to emission light from the light emission surface, and a liquid crystal panel displaying an image with light supplied from the optical sheet. One of the films of the optical sheet that is closest to the liquid crystal panel is a light condensing film that imparts a light condensing function, and the light condensing film includes spacer members for keeping a distance from the liquid crystal panel that are attached on a surface of the light condensing film on a liquid crystal panel side with an adhesive containing an antistatic agent.

### CROSS REFERENCE TO RELATED APPLICATION

This application claims priority from U.S. Provisional Application No. 62/685,575 filed on Jun. 15, 2018. The entire contents of the priority application are incorporated herein by reference.

### TECHNICAL FIELD

The present technology relates to a liquid crystal display device.

### BACKGROUND

A liquid crystal display device includes a liquid crystal panel and a lighting device that delivers light to a display area of the liquid crystal panel. The lighting device includes, for example, a light source, a light guide plate that guides light from the light source, and an optical sheet that imparts an optical action to emission light from the light guide plate. The optical sheet is formed by stacking a plurality of films such as a light condensing film that imparts a light condensing function to light and a diffusion film that diffuses transmitted light. According to Patent Literature 1 below, when those plurality of films are disposed in close contact with each other, moire, Newton's ring, or the like may be generated to induce display unevenness; therefore, in order to prevent the close contact between the plurality of films, a number of projections are formed on a surface of the film.

### RELATED ART DOCUMENT

### Patent Document

[Patent Literature 1] Japanese Translation of PCT International Application Publication No. JP-T-2011-513771

The cause of the moire, Newton's ring, or the like is not just the close contact between the plurality of films. The recent liquid crystal display devices have become thinner, and as the thickness is reduced, the thickness of the optical films, for example, the plurality of films of the optical sheet and the polarizing plate in the liquid crystal panel have particularly been reduced in thickness. Those optical films, which are generally formed of an insulating material, are charged with electricity and this charging results in a serious problem because of the thickness reduction. Specifically, when the film in the optical sheet is charged with electricity, a force of attraction operates between the charged film and the liquid crystal panel (polarizing plate) and the film is adsorbed on the polarizing plate. Since the film is thin, the film may be easily deformed and adsorbed on the polarizing plate partially. In particular, if the film in the optical sheet that is on the liquid crystal panel side is the light condensing film, the contact between the mirror-finished surfaces results in the occurrence of the moire, Newton's ring, or the like or the inhomogeneous distance between the light condensing film and the polarizing plate; as a result, the display unevenness occurs.

### SUMMARY

The present technology has been made in view of such a circumstance, and an object is to provide a liquid crystal display device in which the adsorption between the light condensing film and the liquid crystal panel is prevented to keep the distance between the light condensing film and the liquid crystal panel uniform, so that the deterioration in display quality is suppressed.

A liquid crystal display device of the present technology includes a light source; a light guide plate including a pair of plate surfaces and guiding light from the light source and exiting the light through a light emission surface that is one of the plate surfaces; an optical sheet that includes a plurality of films disposed so as to overlap with the light guide plate on a light emission surface side and imparts an optical action to emission light from the light emission surface; and a liquid crystal panel that displays an image with light supplied from the optical sheet. One of the plurality of films of the optical sheet that is closest to the liquid crystal panel is a light condensing film that imparts a light condensing function. The light condensing film includes spacer members for keeping a distance from the liquid crystal panel that are attached on a surface of the light condensing film on a liquid crystal panel side with an adhesive containing an antistatic agent.

In the liquid crystal display device with such a structure, the spacer members are attached to the surface of the light condensing film that is closest to the liquid crystal panel; therefore, the light condensing film is not adsorbed on the liquid crystal panel (polarizing plate). In addition, the adhesive used to attach the spacer members to the light condensing film contains the antistatic agent; therefore, the displacement of the light condensing film toward the liquid crystal panel can be reduced. As a result, in the liquid crystal display device with this structure, the charging of the light condensing film can be reduced, so that the displacement of the light condensing film toward the liquid crystal panel can be reduced, and additionally, the distance between the light condensing film and the liquid crystal panel can be maintained uniform by the spacer members. That is to say, in the liquid crystal display device with this structure, the occurrence of the moire, Newton's ring, or the like is suppressed and the display unevenness is also suppressed.

In the liquid crystal display device with this structure, the adhesive may contain a number of spacer members in addition to the antistatic agent and by applying this adhesive to the light condensing film, the spacer members may be attached to the light condensing film. Alternatively, after the adhesive containing the antistatic agent is applied to the light condensing film, the spacer members may be dispersed such that the spacer members are attached to the light condensing film.

According to the present technology, a liquid crystal display device in which the adsorption between an optical sheet and a liquid crystal panel is prevented to keep the distance between the optical sheet and the liquid crystal panel uniform, so that the deterioration in display quality is suppressed can be provided.

### BRIEF DESCRIPTION OF THE DRAWINGS

FIG. 1 is an exploded perspective view of a liquid crystal display device according to one example of the present technology.

FIG. 2 is a side cross-sectional view (II-II sectional view in FIG. 1) of the liquid crystal display device according to the example of the present technology.

FIG. 3 is a magnified cross-sectional view illustrating a second prism film used as a light condensing film illustrated in FIG. 2.

FIG. 4 is a magnified cross-sectional view illustrating a second prism film in a liquid crystal display device according to a modification of the present technology.

### DETAILED DESCRIPTION

One example of the present technology will be hereinafter described in detail as a mode for carrying out the present technology with reference to the drawings. The present technology is not limited to the example below, and can be carried out with various changes and improvements based on the knowledge of a person skilled in the art.

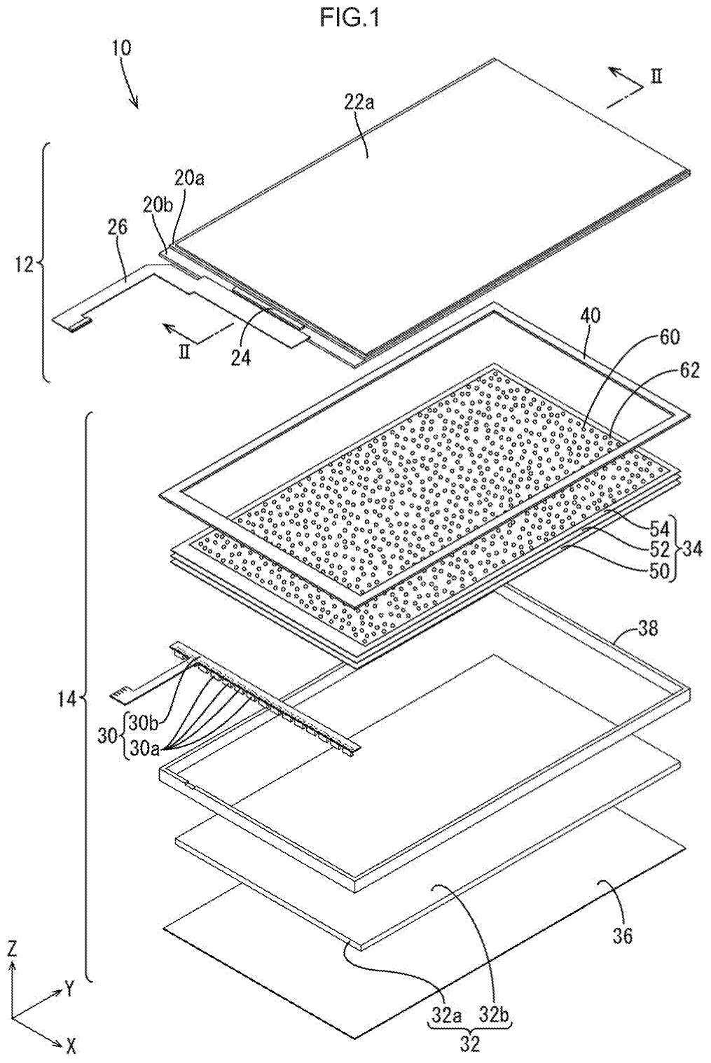

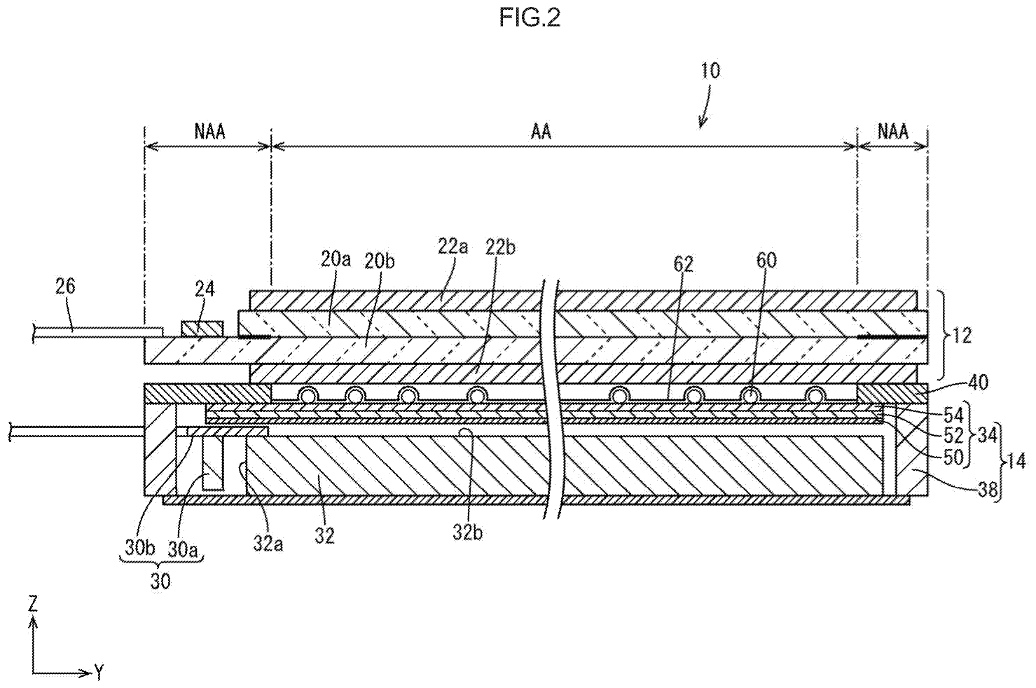

A liquid crystal display device 10 corresponding to one example of the present technology is illustrated in an exploded perspective view in FIG. 1 and a cross-sectional view in FIG. 2. The liquid crystal display device 10 has a vertically long rectangular shape as a whole as illustrated in FIG. 1. The liquid crystal display device 10 includes a liquid crystal panel 12 that can display an image, and a backlight device 14 that delivers light for image display to the liquid crystal panel 12. The present liquid crystal display device 10 is used for, but not limited to, a mobile information terminal such as a smart phone. Note that an X axis, a Y axis, and a Z axis are shown in a part of each drawing, and each axial direction is common throughout the drawings. A short-side direction of the liquid crystal display device 10 coincides with an X-axis direction in each drawing, and a long-side direction thereof coincides with a Y-axis direction in each drawing. In addition, a direction orthogonal to an XY plane coincides with a Z-axis direction, and on the basis of FIG. 2, may be referred to as an up-down direction.

The liquid crystal panel 12 includes a pair of substrates 20a and 20b that are substantially transparent and have the excellent light-transmitting property. Of the pair of substrates 20a and 20b, the substrate on the upper side (front side) is a CF substrate 20a and the substrate on a lower side (back side) is an array substrate 20b. On an outer surface side of the pair of substrates 20a and 20b, a pair of polarizing plates 22a and 22b is pasted. In the liquid crystal panel 12, the pair of substrates 20a and 20b is pasted to each other with a predetermined gap therebetween. The liquid crystal panel 12 includes a liquid crystal layer and a sealing part (neither are shown). The liquid crystal layer is held between the pair of substrates 20a and 20b and contains liquid crystal molecules whose optical characteristic changes as an electric field is applied. The sealing part is provided to surround the liquid crystal layer and seal the liquid crystal layer. The array substrate 20b has one end part in a long-side direction projecting outward over the CF substrate 20a. The projecting part is provided with, for example, a driver 24 for driving the liquid crystal panel 12, and a flexible substrate 26 for electrically connecting the liquid crystal panel 12 and an external panel control board.

An internal structure of the liquid crystal panel 12 will be described briefly with some of various structures regarding the internal structure not illustrated. On an inner surface side of the array substrate 20b, a number of TFTs (Thin Film Transistors) corresponding to switching elements and pixel electrodes are arranged in matrix (rows and columns). On the inner surface side of the array substrate 20b, gate lines and source lines are disposed in the lattice form to surround the TFTs and the pixel electrodes. To the gate lines and the source lines, signals for an image are transmitted. On the other hand, on an inner surface side of the CF substrate 20a, a number of color filters are provided at positions in accordance with the pixel electrodes. The color filters of three colors of R, G, and B are arranged alternately. On the inner surface side of the CF substrate 20a, a light-blocking part (black matrix) 28 is provided to prevent color mixing between the adjacent color filters. Although not shown in detail, the light-blocking part 28 is formed to have a lattice form to section between the adjacent color filters in a display area AA at a central part of the liquid crystal panel 12. On the other hand, in a non-display area NAA in an outer peripheral part of the liquid crystal panel 12, the light-blocking part 28 is formed in a solid form.

The backlight device 14 is disposed on a back side of the liquid crystal panel 12 and includes a light source 30, a light guide plate 32 with a rectangular plate shape that guides light from the light source 30, an optical sheet 34 that is disposed on a front side of the light guide plate 32, a reflection sheet 36 that is disposed on a back side of the light guide plate 32, and a frame 38 with a shape of surrounding the light source 30, the light guide plate 32, and the optical sheet 34. The backlight device 14 is an edge light device of one-side light incidence type that allows the light of the light source 30 to enter the light guide plate 32 only from one side. The light source 30 is disposed on one end side of the long-side direction of the backlight device 14.

The light source 30 includes a plurality of LEDs 30a (Light Emitting Diode: Light-emitting diode) and an LED substrate 30b on which the LEDs 30a are mounted. Each LED 30a is formed by having an LED chip sealed with a sealing material. The LED chip emits light with a single color such as blue light, and each LED 30a emits white light as a whole when a fluorescent substance (such as yellow fluorescent substance, green fluorescent substance, and red fluorescent substance) is diffused in the sealing material. The structure of the LED 30a is not limited to the aforementioned structure and can be changed as appropriate. The LED substrate 30b is a flexible film (sheet) shaped substrate made of an insulating material, and on the LED substrate 30b, the plurality of LEDs 30a are mounted with a space therebetween. The plurality of LEDs 30a are arranged at equal intervals but the arrangement is not limited thereto.

The light guide plate 32 is made of a substantially transparent synthetic resin material (for example, polycarbonate or acrylic resin such as PMMA), and has a refractive index sufficiently higher than that of air. The light guide plate 32 has a vertically long rectangular shape similar to the liquid crystal panel 12 as illustrated in FIG. 1. As illustrated in FIG. 2, one surface of four outer peripheral end surfaces of the light guide plate 32 is a light incidence surface 32a that is disposed to face the light source 30 to receive the light. The light incidence surface 32a is extended linearly along a direction where the plurality of LEDs 30a are arranged (see FIG. 1). The light emitted from the light source 30 enters the light guide plate 32 through the light incidence surface 32a. On the other hand, one of a pair of plate surfaces of the light guide plate 32 that faces the front side (liquid crystal panel 12 side) is a light emission surface 32b. The light having entered the light guide plate 32 propagates in the light guide plate 32 and then is emitted from the light emission surface 32b toward the optical sheet 34.

The reflection sheet 36 is disposed to overlap with an emission light opposite plate surface 32c, that is, a plate surface of the pair of plate surfaces of the light guide plate 32 that faces the back side. The reflection sheet 36 is excellent in light reflectivity, and can make the light, which has leaked from the emission light opposite plate surface 32c of the light guide plate 32, rise efficiently toward the front side (light emission surface 32b).

The frame 38 is made of synthetic resin (for example, polycarbonate) and a front surface thereof exhibits white color. The frame 38 has a frame-like outer shape that is a little larger than the light guide plate 32. The frame 38 is disposed to surround and contain the light source 30, the light guide plate 32, and the optical sheet 34. The frame 38 is fixed to the liquid crystal panel 12 through a fixing tape 40. The fixing tape 40 has a vertically long frame shape (annular shape) similar to the frame 38 and the non-display area NAA of the liquid crystal panel 12 as illustrated in FIG. 1. The fixing tape 40 attaches and fixes the polarizing plate 22b on the back side of the liquid crystal panel 12 and an upper end of the frame 38 as illustrated in FIG. 2. The fixing tape 40 also attaches and fixes a front surface of the optical sheet 34, which will be described in detail below, and the polarizing plate 22b. Note that the fixing tape 40 is desirably a light-blocking double-sided tape with a sticky agent applied on both surfaces of a base bacterial with a light-blocking property.

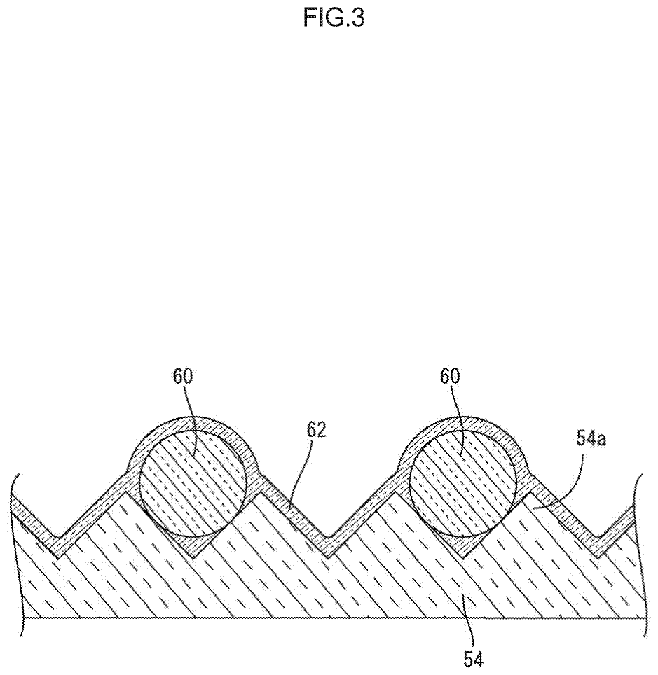

Next, the optical sheet 34, which is one feature of the present technology, is described in detail. The optical sheet 34 is disposed on the light emission surface 32b side of the light guide plate 32, and while imparting an optical action to the emission light resulting from the light emission surface 32b, the optical sheet 34 emits the light toward the liquid crystal panel 12. The optical sheet 34 has three films, that is, a diffusion film 50, a first prism film 52, and a second prism film 54, stacked in this order from the back side. The diffusion film 50 has a structure in which a number of diffusion particles are diffused in a base material made of synthetic resin that is substantially transparent, and has a function of diffusing the transmitted light. Each of the first prism film 52 and the second prism film 54 has a structure in which a number of prisms (see FIG. 3 for prisms 54a in the second prism film 54) extended along one direction are arranged on a plate surface of a base material made of synthetic resin that is substantially transparent, and exerts a light condensing function selectively in the direction where the prisms are arranged. The first prism film 52 and the second prism film 54 are disposed with their prisms arranged orthogonal to each other.

Here, a problem of the conventional liquid crystal display device is described. The films 50, 52, and 54 of the optical sheet 34 have become thinner and thinner, and because of the small thickness, the films 50, 52, and 54 are easily bent. The films 50, 52, and 54 are formed of an insulating material such as polycarbonate or acrylic, and the polarizing plate 22b is also formed of an insulating material. Therefore, charging easily occurs between the polarizing plate 22b and the second prism film 54 that is disposed closest to the liquid crystal panel 12 in the optical sheet 34. Between the liquid crystal panel 12, specifically, the polarizing plate 22b and the second prism film 54 that is disposed closest to the liquid crystal panel 12 in the optical sheet 34, there is a clearance corresponding to the thickness of the fixing tape 40. However, if charging occurs between the second prism film 54 and the polarizing plate 22b, the second prism film 54 may be attracted to the polarizing plate 22b, and in this case, a part of the second prism film 54 is adsorbed on the polarizing plate 22b. Both the second prism film 54 and the polarizing plate 22b have their surfaces mirror-finished. If the both are in contact, an optical interference such as moire or Newton's ring occurs and this results in display unevenness.

The present liquid crystal display device 10 has a structure that solves the above problem. Specifically, first, among the three films of the optical sheet 34, the second prism film 54 that is disposed closest to the polarizing plate 22b includes a number of prisms 54a on the front surface as illustrated in FIG. 3, and to the front surface provided with the prisms 54a, a number of beads 60 are attached as the spacer members. These beads 60 are made of polyurethane and have a spherical shape in the present example. In addition, each of the beads 60 has the outer diameter (for example, 20 to 30 μm) that is sufficiently larger than the depth of the groove of the prism 54a (for example, about 10 μm), and the bead 60 projects toward the polarizing plate 22b over the top of the prism 54a.

The beads 60 are attached to the second prism film 54 through a binder 62. The binder 62 is mainly made of an acrylic resin adhesive and contains an antistatic agent. The beads 60 are attached to the second prism film 54 with the binder 62 in a manner that the beads 60 are mixed in the binder 62 and the mixture is applied to the surface of the second prism film 54. Note that the binder 62 is applied to the periphery of the second prism film 54 except the place where the fixing tape 40 is pasted, that is, the range corresponding to the display area AA in the liquid crystal panel 12. In addition, although how the binder 62 is applied is not limited to a particular method, it is desirable to select a method that can apply the binder 62 uniformly to an uneven surface because the binder 62 is applied to the surface of the second prism film 54 where the prisms 54a are formed.

That is to say, in the present liquid crystal display device 10, the beads 60 are covered with the binder 62 as illustrated in FIG. 3. Therefore, in the present liquid crystal display device 10, the range in the second prism film 54 that corresponds to the display area AA is covered with the binder 62 containing the antistatic agent; therefore, the charging between the second prism film 54 and the polarizing plate 22b can be suppressed effectively.

With such a structure, in the present liquid crystal display device 10, the charging between the second prism film 54, which is the light condensing film, and the polarizing plate 22b can be suppressed effectively by the binder 62 containing the antistatic agent, and the displacement of the second prism film 54 to the polarizing plate 22b can be suppressed. In addition, since the second prism film 54 has many beads 60, which function as the spacer, attached thereto through the binder 62, the distance between the second prism film 54 and the polarizing plate 22b can be secured. Thus, the adsorption of the second prism film 54 to the polarizing plate 22b, more specifically, the contact of the prisms 54a of the second prism film 54 with the polarizing plate 22b can be prevented for sure and additionally, the distance between the second prism film 54 and the polarizing plate 22b can be maintained uniform. Therefore, in the present liquid crystal display device 10, the occurrence of the moire, Newton's ring, or the like is suppressed and the display unevenness is also suppressed; accordingly, the display quality is enhanced.

<Modification>

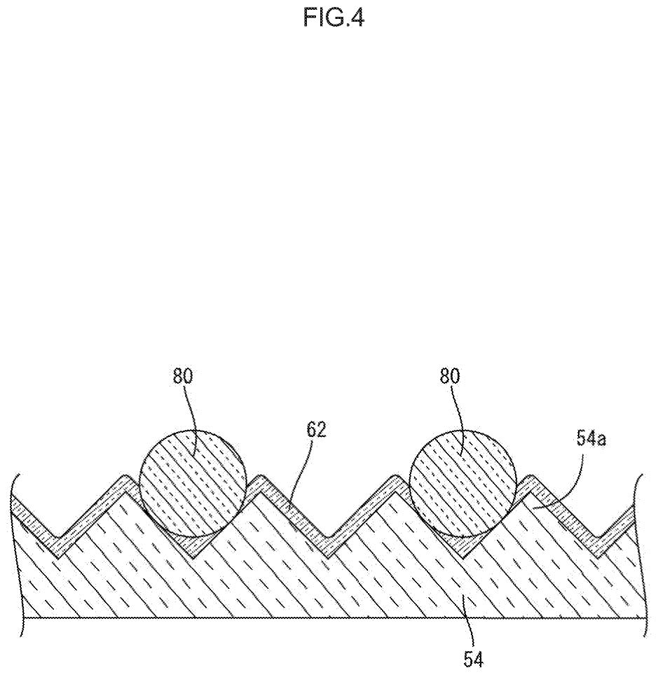

In the liquid crystal display device 10 according to the above example, only the adhesive contains the antistatic agent; however, the spacer member may also contain the antistatic agent. In this structure, the charging between the second prism film 54 and the polarizing plate 22b can be suppressed further. Note that if the spacer members are beads 80 containing the antistatic agent, the beads 80 may be attached to the second prism film 54 in a manner that after the binder 62 is applied and before the binder 62 is cured, the beads 80 are dispersed. In this case, as illustrated in FIG. 4, the binder 62 can have uniform thickness and the influence on the display in the liquid crystal panel 12 can be suppressed.

In the example and the modification described above, the spacer members are the beads 60 and 80 that are spherical; however, the shape is not limited to the spherical shape. It should be noted that, however, the spherical spacer member can prevent the polarizing plate 22b from being damaged if the spacer member is in contact with the polarizing plate 22b. The material of the spacer member is not limited to a particular material; however, it is desirable to use a relatively soft material because the spacer member may be in contact with the polarizing plate 22b. Furthermore, if the film in the optical sheet that is closest to the liquid crystal panel 12 is a prism film that faces downward (having prisms on the back surface), a flat surface of the film on the liquid crystal panel 12 side can have the spacer members attached with the adhesive containing the antistatic agent.

1. A liquid crystal display device comprising:
a light source;
a light guide plate including a pair of plate surfaces and guiding light from the light source and exiting the light through a light emission surface that is one of the plate surfaces;
an optical sheet that includes a plurality of films disposed so as to overlap with the light guide plate on a light emission surface side and imparts an optical action to emission light from the light emission surface; and
a liquid crystal panel that displays an image with light supplied from the optical sheet, wherein
one of the plurality of films of the optical sheet that is closest to the liquid crystal panel is a light condensing film that imparts a light condensing function, and
the light condensing film includes spacer members for keeping a distance from the liquid crystal panel that are attached on a surface of the light condensing film on a liquid crystal panel side with an adhesive containing an antistatic agent.

2. The liquid crystal display device according to claim 1, wherein the spacer members contain an antistatic agent.

3. The liquid crystal display device according to claim 1, wherein the light condensing film includes a mixture of the spacer members in the adhesive containing the antistatic agent applied on the surface on the side of the liquid crystal panel.

4. The liquid crystal display device according to claim 1, wherein the spacer members are spherical.

5. The liquid crystal display device according to claim 1, wherein
the light condensing film includes a prism on at least the surface on the side of the liquid crystal panel, and
the spacer members have a size of projecting to the side of the liquid crystal panel over a top of the prism.
